(19) United States
(12) Patent Application Publication
(10) Pub. No.: US 2025/0347459 A1
(43) Pub. Date: Nov. 13, 2025

(54) Multi-Tier, In-Line Immersive Processing System

(71) Applicant: Georgia Tech Research Corporation, Atlanta, GA (US)

(72) Inventors: Comas Haynes, Atlanta, GA (US); Aklilu Giorges, Atlanta, GA (US); Alexander Samoylov, Atlanta, GA (US); Francisco Valdes, Atlanta, GA (US)

(21) Appl. No.: 18/862,390

(22) PCT Filed: May 2, 2023
(86) PCT No.: PCT/US2023/066488

§ 371 Date: Nov. 1, 2024

Related U.S. Application Data
(60) Provisional application No. 63/337,356, filed on May 2, 2022.

(51) Int. Cl. F25D 13/06; A22B 5/00; A22B 7/00

(52) U.S. Cl. CPC F25D 13/065; A22B 5/0076; A22B 5/0082; A22B 7/002

(57) ABSTRACT

An automated immersive chilling system wherein the system may comprise a shackle and a track. The shackle may be configured to cooperatively attach to a product to be cooled. The track may be configured to move the shackle along a processing line wherein the processing line may comprise one or more curved channels retaining a reservoir of a cooling medium. The shackle may be configured to move the product within the reservoir to agitate the cooling medium. The shackle can be a rotating shackle that can be configured to move the product within the reservoir to agitate the cooling medium by rotating the shackle in the reservoir of the cooling medium. The shackle may be further configured to move the product within the reservoir to agitate the cooling medium by vibrating the shackle in the reservoir.

### CROSS-REFERENCE TO RELATED APPLICATIONS

This application claims the benefit of U.S. Provisional Application Ser. No. 63/337,356, filed on 2 May 2022, which is incorporated herein by reference in its entirety as if fully set forth below.

### FIELD OF INVENTION

The various embodiments of the present disclosure relate generally, to multi-tier processing systems and methods, and more specifically, to in-line immersive chilling processing systems and methods for meat products.

### BACKGROUND

Within meat product processing plants and facilities, limiting the growth of disease producing microorganisms and food ruining microorganisms during the processing of meat product is highly desirable. For example, in poultry processing plants and facilities, poultry carcasses are chilled to mitigate the growth of both disease producing microorganisms and food ruining microorganisms. Conventional approaches to chilling poultry carcasses include water chilling and air chilling. Water chilling, also known as immersion chilling, involves fully immersing the carcasses in one or more tanks of water to lower the temperature, and reduce the risks of pathogens. However, with conventional immersion chilling, poultry carcasses have to be rehung back on to shackles, which presents various challenges during poultry processing Air chilling involves moving poultry carcasses secured to shackles through coolers with rapidly moving air to lower the temperature. Air chilling, however, is less thermally efficient than water chilling.

Thus, there still exists a need for a system that can achieve more uniform heat transfer during the chilling process, limits the presence of disease producing microorganisms and food spoiling microorganisms on meat products, and promotes energy efficiency through reduction of footprint within meat product processing facilities. Accordingly, in-line immersive chilling systems and methods for meat products moving through the processing steps within meat product processing plants and facilities can address the aforementioned challenges.

### SUMMARY

An exemplary embodiment of the present disclosure provides an automated immersive chilling system wherein the system may comprise a shackle and a track. The shackle may be configured to cooperatively attach to a product to be cooled. The track may be configured to move the shackle along a processing line wherein the processing line may comprise one or more channels retaining a reservoir of a cooling medium. The shackle may be configured to move the product within the reservoir to agitate the cooling medium.

In any of the embodiments disclosed herein, the one or more channels may be curved.

In any of the embodiments disclosed herein, the shackle can be a rotating shackle, wherein the rotating shackle may be configured to move the product within the reservoir to agitate the cooling medium by rotating the shackle in the reservoir of the cooling medium.

In any of the embodiments disclosed herein, the rotating shackle may comprise a rotator wherein the rotator can be coupled to the rotating shackle and configured to cause rotational motion of the rotating shackle.

In any of the embodiments disclosed herein, the rotating shackle may be configured to rotate the product via the rotator within the reservoir to agitate the cooling medium in a clockwise direction, a counterclockwise direction, or a combination thereof.

In any of the embodiments disclosed herein, the shackle may be further configured to move the product within the reservoir to agitate the cooling medium by vibrating the shackle in the reservoir.

In any of the embodiments disclosed herein, the processing line may comprise one or more troughs that can be configured to guide the shackle along the processing line to the one or more channels. The one or more troughs can be connected in series.

In any of the embodiments disclosed herein, the processing line may comprise a plurality of tiers wherein the plurality of tiers can comprise a first tier, a second, tier and a third tier. The first tier may comprise one or more channels that can retain the reservoir of the cooling medium. The second tier may comprise one or more channels that can retain a reservoir of a chemical medium. The third tier may comprise one or more channels that can retain a reservoir of a sanitizing medium. Each of the plurality of tiers may comprise one or more troughs connected in series and can be configured to guide the shackle along the processing line to the one or more channels.

In any of the embodiments disclosed herein, each of the one or more curved channels on each of the plurality of tiers may be curved

In any of the embodiments disclosed herein, each of the plurality of tiers may be arranged vertically, horizontally, or a combination thereof.

In any of the embodiments disclosed herein, the system may further comprise a trolley coupled to the track that can be configured to undergo translational motion while the shackle moves along the processing line.

In any of the embodiments disclosed herein, the product supported by the rotating shackle can be poultry.

In any of the embodiments disclosed herein, the cooling medium retained in the reservoir can be an ice slurry, chilled water or a combination thereof.

In any of the embodiments disclosed herein, the cooling medium retained in the reservoir may comprise a sanitizing agent configured to disinfect the product on the shackle.

Another embodiment of the present disclosure provides a method for automated immersive chilling of a product wherein the method may comprise securing a product to a shackle system on a track, translating the product secured to the shackle system along the track within a processing line, immersing the product secured to the shackle system in a reservoir of a cooling medium within the processing line, and agitating the cooling medium.

In any of the embodiments disclosed herein, translating the product secured to the shackle system may comprise moving the product via a trolley, wherein the trolley may be coupled to the track. The trolley can be configured to undergo translational motion along the track and can thereby cause the shackle system to move along the track.

In any of the embodiments disclosed herein, agitating the cooling medium may comprise rotating the product on a rotating shackle within the reservoir of the cooling medium in a clockwise direction, a counterclockwise direction, or a combination thereof.

In any of the embodiments disclosed herein, the shackle system may comprise the rotating shackle and the rotating shackle may comprise a rotator.

In any of the embodiments disclosed herein, the rotator can be configured to cause rotational motion of the rotating shackle.

In any of the embodiments disclosed herein, agitating the cooling medium may comprise vibrating the product on a shackle within the reservoir of the cooling medium, wherein the shackle system may comprise the shackle.

In any of the embodiments disclosed herein, wherein the processing line may comprise one or more troughs that can be configured to guide the product on the shackle system through the processing line. The processing line may comprise one or more channels configured to retain the reservoir of the cooling medium.

In any of the embodiments disclosed herein, the processing line may comprise a plurality of tiers wherein the plurality of tiers may comprise a first tier, a second tier, and a third tier. The first tier may comprise one or more channels that can retain the reservoir of the cooling medium. The second tier may comprise one or more channels that can retain a reservoir of a chemical medium. The third tier may comprise one or more channels that can retain a reservoir of a sanitizing medium. Each of the plurality of tiers may have one or more troughs that can be connected in series and can be configured to guide the shackle along the processing line to the one or more channels. Each of the plurality of tiers can be arranged vertically, horizontally, or a combination thereof.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF DRAWINGS

The above and further aspects of this invention are further discussed with reference to the following description in conjunction with the accompanying drawings, in which like numerals indicate like structural elements and features in various figures. The drawings are not necessarily to scale, emphasis instead being placed upon illustrating principles of the invention. The figures depict one or more implementations of the inventive devices, by way of example only, not by way of limitation.

FIGS. 1A and 1B are illustrations of a first and second view of the multi-tier, in-line immersive chilling system in accordance with exemplary embodiments of the present disclosure.

FIG. 2 is an illustration of a cross-sectional view of one tier of the plurality of tiers within a multi-tier, in-line immersive chilling system in accordance with some exemplary embodiments of the present disclosure.

FIGS. 3A and 3B are illustrations of a top view and a side view of a product attached to the shackle of a multi-tier, in-line immersive chilling system being used to agitate the cooling medium in accordance with some exemplary embodiments of the present disclosure.

FIG. 4 is method flow chart for using a multi-tier, in-line immersive chilling system in accordance with some exemplary embodiments of the present disclosure.

### DETAILED DESCRIPTION

The following detailed description should be read with reference to the drawings, in which like elements in different drawings are identically numbered. This description enables one skilled in the art to make and use the invention, and describes several embodiments, adaptations, variations, alternatives and uses of the invention, including what is presently believed to be the best mode of carrying out the invention. Any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those skilled in the pertinent art in view of the teachings herein. Such modifications and variations are intended to be included within the scope of the claims.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

By “comprising” or “containing” or “including” is meant that at least the named compound, element, particle, or method step is present in the composition or article or method, but does not exclude the presence of other compounds, materials, particles, method steps, even if other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

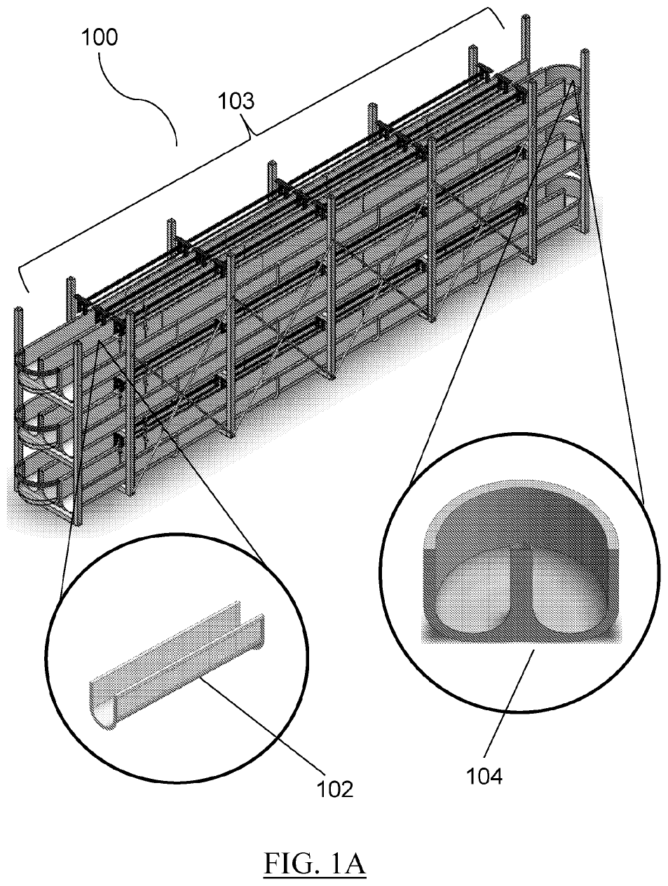

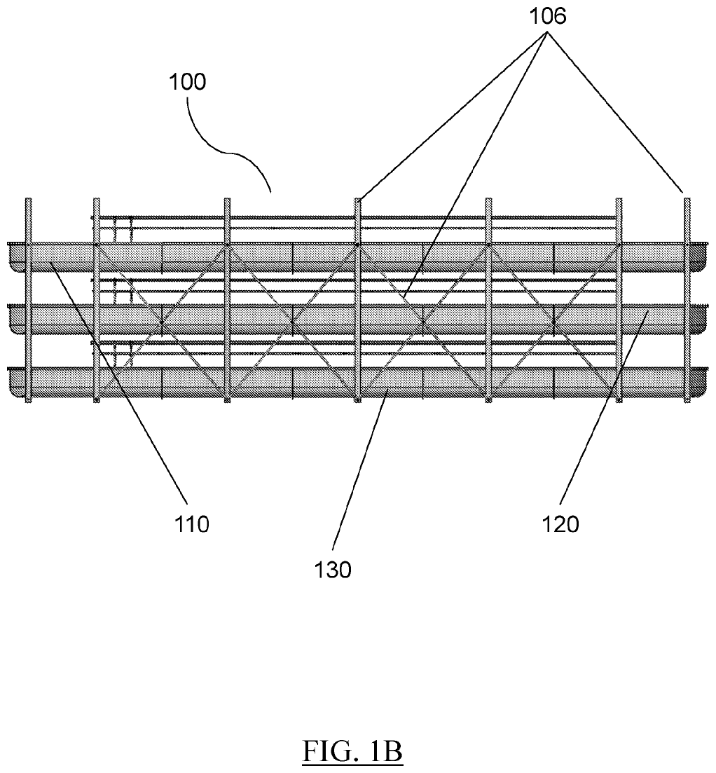

FIGS. 1A and 1B are illustrations of a first and second view of an exemplary multi-tier, in-line immersive chilling system 100. The multi-tier, in-line immersive chilling system 100 can include a plurality of tiers 110, 120, 130 as shown in FIG. 1B. In some embodiments, the system 100 can include a first tier 110, a second tier 120, and a third tier 130. As shown in FIGS. 1A and 1B, each of the tiers may be arranged vertically, which can be advantageous for reducing the footprint of the system 100 within a meat processing plant or facility. In addition to each of the tiers of the system 100 being arranged vertically, the tiers can also be arranged horizontally or a combination that can include both a horizontal and vertical arrangement. Each tier of the system may be supported by one or more truss structures 106 as shown in FIG. 1B. As one skilled in the art will appreciate, the material composition of the one or more truss structures 106 can include but not be limited to aluminum, stainless steel alloys, and the like.

As shown in FIG. 1A, each tier of the multi-tier, in-line immersive chilling system 100 can include a processing line 103. The processing line 103 can include one or more channels 104 and can also include one or more troughs 102. As shown in FIG. 1A, the one or more troughs can be connected in series and can be configured to guide the product 114 on the processing line 103 to the one or more channels 104. In some embodiments, the product 114 moving through the processing line 103 can be a poultry carcass. As shown in FIG. 1A, the one or more channels 104 may resemble a “U” shape and can be configured to retain a reservoir of a cooling medium 116. In some embodiments, the one or more channels may be curved channels. It should be appreciated that the one or more channels can be molded or extruded to resemble a variety of form factors, shapes, or configurations. The cooling medium 116 can be any cooling medium known in the art including but not limited to, an ice slurry, chilled water, a combination of both ice slurry and chilled water, and the like. In some embodiment, the reservoir of the cooling medium 116 may also comprise a sanitizing agent that can be configured to disinfect the product 114.

As shown in FIG. 1A, each tier of the plurality of tiers for the system 100 can include one or more channels 104 that may be configured to retain a reservoir of a cooling medium 116. As one skilled in the art will appreciate, meat product within meat processing plants and facilities may be treated using various mediums throughout meat product processing. For example, within poultry processing, poultry carcasses can be treated with various mediums while moving through the processing line 103, which could include but not be limited to a cooling medium 116, a chemical medium, a sanitizing medium and the like. With respect to the present disclosure, the multi-tier, in-line immersive chilling system 100 can have each tier be configured to be a separate treatment zone, wherein the product 114 while moving through the processing line 103 can be treated with a different medium within the one or more channels 104 on each tier as shown in FIG. 1A. It should be appreciated that each of the one or more channels on each of the plurality of tiers may be curved.

In some embodiments, the first tier 110 may include one or more curved channels 104 configured to retain a reservoir of a cooling medium 116, wherein the cooling medium 116 may be chilled water, ice slurry, or a combination thereof. Once the products 114 complete the first tier 110, the products can transition to the second tier 120. In some embodiments, the second tier 120 may include one or more curved channels 104 configured to retain a reservoir of a chemical medium, wherein the chemical medium may be an antimicrobial that can eliminate harmful or food spoiling microorganisms on the product 114. Once the products 114 complete the second tier 120, the products 114 can transition to the third tier 130 The third tier 130 may include one or more curved channels 104 that can retain a reservoir of a sanitizing medium, wherein the sanitizing medium can be configured to remove residual harmful or food spoiling microorganisms left on the product 114 from the second tier 120. One of the advantages of utilizing multiple treatment zones on each of the tiers of the system 100, in a poultry processing application for example, can provide for enhanced heat transfer during the chilling of poultry carcasses. Additionally, in-line processing of poultry carcasses can eliminate/reduce the need to rehang poultry carcasses and can thereby enhance product yield for poultry processing plants and facilities.

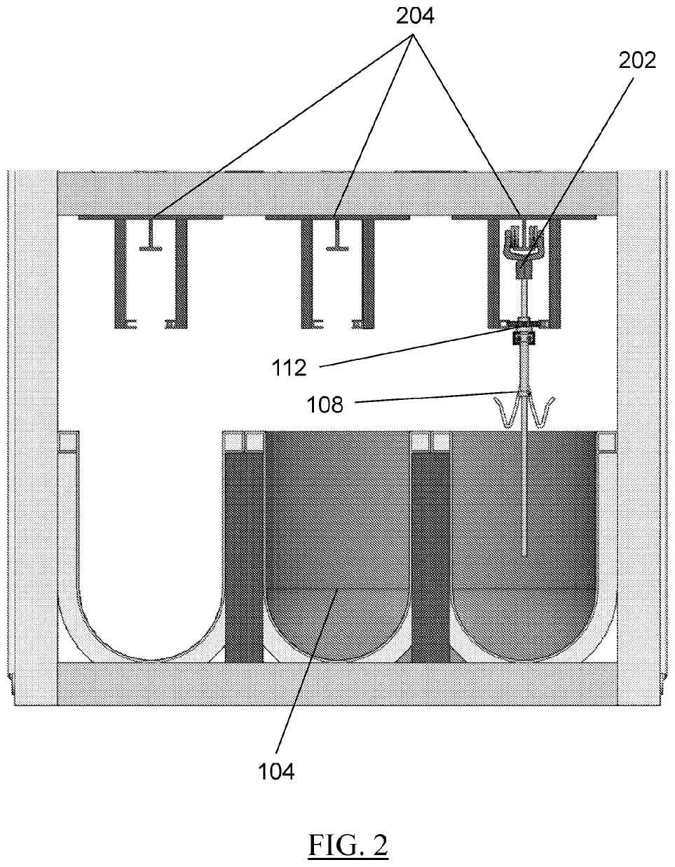

FIG. 2 is an illustration of a cross-sectional view of one tier of the plurality of tiers within the multi-tier, in-line immersive chilling system 100. In some embodiments, the system 100 can also include a shackle 108 that can be configured to cooperatively attach to a product 114 and can also be configured to move the product within the reservoir to agitate the cooling medium 116. The system 100 can also include a track 204 which can be configured to move the shackle along the processing line 103 to the one or more channels 104. The system 100 can also include a trolley 202, which can be coupled to the track 204, and can be configured to undergo translational motion while the shackle 108 moves along the processing line 103.

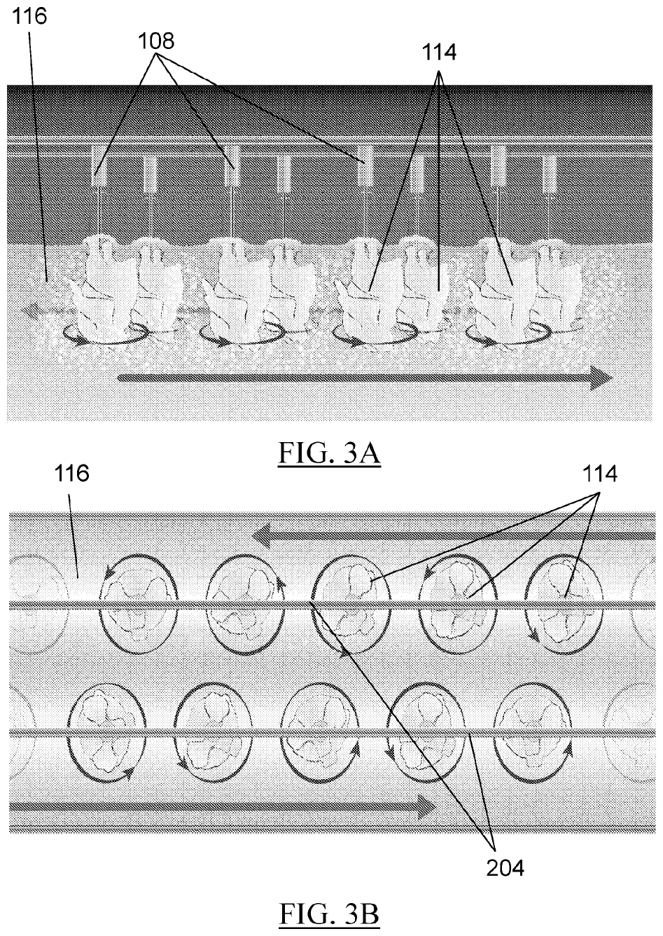

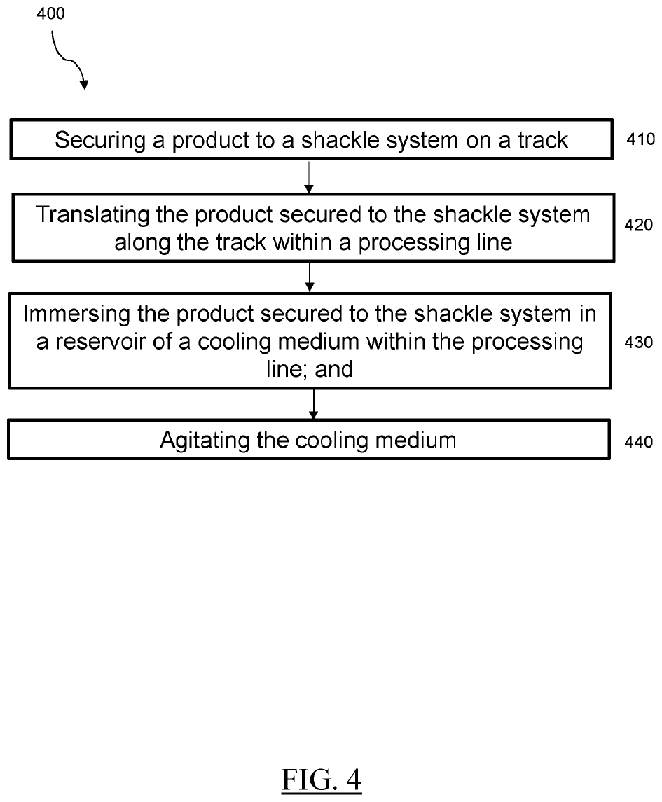

As one skilled in the art will appreciate, agitation can be motions including but not limited to vibration, stirring, rotation and the like. With respect to the present disclosure, a product 114, such as a poultry carcass, cooperatively attached to the shackle 108 can move within the reservoir to agitate the cooling medium 116 via vibration. In some embodiments, the shackle 108, as shown in FIG. 2, can be a rotating shackle that can be configured to rotate the product 114 via a rotator 112, wherein the rotator 112 can be coupled to the rotating shackle and may be configured to cause rotational motion of the rotating shackle. An example of a rotating shackle, as disclosed in the present application, can also be shown in PCT Patent Publication #WO2022072841 which is incorporated herein by reference in its entirety as if fully set forth below. In some embodiments, the rotating shackle can be configured to rotate the product 114 via the rotator 112 within the reservoir to agitate the cooling medium 116 in a clockwise direction, counterclockwise direction, or a combination thereof, as shown in FIG. 3.

FIGS. 3A and 3B are illustrations of a top view and a side view of a product 114 attached to the shackle 108 of the multi-tier, in-line immersive chilling system 100 being used to agitate the cooling medium 116. As mentioned previously, the shackle 108 shown in FIG. 2 may be a rotating shackle or a shackle that can use other types of agitation motion to agitate the cooling medium 116. FIGS. 3A and 3B denote the direction of the products moving within the multi-tier, in-line immersive chilling system 100 as well as the rotational motion of the products attached to each of the shackles 108. As one skilled in the art will appreciate, rotation of a product 114, such as a poultry carcass, in an optimized clockwise, counterclockwise, or combination thereof pattern of motion can enhance heat transfer during chilling of the poultry carcass. Specifically, by using the poultry carcass as an agitator within the cooling medium 116, there can be increased efficacy of chilling the poultry carcass thus lowering the temperature more rapidly than conventional methods. Furthermore, the optimized rotational patterns of motion achieved through using the poultry carcass as an agitator can reduce the risk of agglomeration on the poultry carcass. For example, assuming the cooling medium 116 is an ice slurry, using optimized clockwise, counterclockwise, or a combination thereof patterns of motion within the ice slurry may minimize adhesion and agglomeration of ice slurry on the surface of the poultry carcass.

FIG. 4 is method flow chart 400 for using the multi-tier, in-line immersive chilling system 100. The first step 410 can include securing a product 114 to a shackle system on a track 204. The next step 420 can include translating the product 114 secured to the shackle system along the track 204 within a processing line 103. In some embodiments, translating the product 114 secured to the shackle system can include moving the product 114 via a trolley 202 that can be configured to undergo translational motion along the track 204 and thereby can cause the shackle system to move along the track 204. As should be appreciated, the trolley 202 may be coupled to the track 204. The next step 430 can include immersing the product 114 secured to the shackle system in a reservoir of a cooling medium 116 within the processing line 103. In some embodiments, the processing line 103 can include one or more troughs 102 that can be configured to guide the product 114 on the shackle system 108 through the processing line 103. In some embodiments, the processing line 103 can also include one or more channels 104 that can be configured to retain the reservoir of the cooling medium 116. In some embodiments, the one or more channels 104 may be curved

The next method step 440 can include agitating the cooling medium 116. In some embodiments, agitating the cooling medium 116 can include rotating the product 114 on a rotating shackle within the reservoir of the cooling medium 116 in a clockwise direction, counterclockwise direction or a combination thereof. It should be appreciated that the shackle system may include the rotating shackle. It should also be appreciated that the rotating shackle may include a rotator 112 that can be configured to cause rotational motion of the rotating shackle and thereby the product 114. In some embodiments, agitating the cooling medium 116 may include vibrating the product on a shackle 108 within the reservoir of the cooling medium 116. It should be appreciated that the shackle system can include the shackle 108.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A shackle configured to:
cooperatively attach to a product to be cooled; and
move the product within a cooling medium.

2. The shackle of claim 1, wherein the shackle is further configured to:
vibrate the product in the cooling medium.

3. The shackle of claim 1, wherein the shackle is further configured to:
impart both rotational and translational kinematics to the product in order to agitate the cooling medium

4. A system comprising:
the shackle of claim 1; and
a track configured to move the shackle along a processing line comprising one or more channels retaining the cooling medium.

5. The system of claim 4, wherein the shackle is further configured to:
rotate the product via a rotator in a clockwise direction, a counterclockwise direction, or a combination thereof.

6. (canceled)

7. The system of claim 4, wherein the processing line further comprises one or more troughs configured to guide the shackle along the processing line to the one or more channels.

8. The system of claim 7, wherein the one or more troughs are connected in series.

9. The system of claim 7, wherein the processing line further comprises:
a first tier comprising one or more curved channels retaining the cooling medium;
a second tier comprising one or more channels retaining a chemical medium; and
a third tier comprising one or more channels retaining a sanitizing medium.

10.-14. (canceled)

15. The system of claim 4, wherein the cooling medium is selected from a group consisting of an ice slurry, chilled water, and a combination thereof.

16.-17. (canceled)

18. The system of claim 4, wherein the cooling medium comprises a sanitizing agent configured to disinfect the product on the shackle.

19. A method for automated immersive chilling of a product comprising:
translating a product along a track of a processing line;
immersing the product in a cooling medium; and
vibrating the product in the cooling medium.

20. The method of claim 19, wherein the translating comprises:
moving the product via a trolley configured to undergo translational motion along the track and thereby cause a shackle system to which the product is secured to move along the track.

21. The method of claim 20, wherein the product in the cooling medium agitates the cooling medium.

22. The method of claim 21, wherein the vibrating comprises vibrating the product on a shackle within the the cooling medium;
wherein the shackle system comprises the shackle.

23.-32. (canceled)

33. An automated immersive chilling system comprising:
the shackle of claim 3; and
a track configured to move the shackle along a processing line.

34. The system of claim 33 further comprising a set of spaced apart tiers comprising:
a first tier with one or more channels retaining the cooling medium;
a second tier with one or more channels retaining a chemical medium; and
a third tier with one or more channels retaining a sanitizing medium;
wherein each of tiers comprises one or more troughs connected in series and configured to guide the shackle along the processing line to the one or more channels.

35. The system of claim 34, wherein the tiers are arranged vertically, horizontally, or a combination thereof.

36. The system of claim 35, wherein the cooling medium is selected from a group consisting of chilled water, ice slurry, and a combination thereof.

37. The system of claim 36 further comprising:
one or more troughs configured to guide the shackle along the processing line to the one or more channels;
one or more truss structures configured to support the tiers; and
a trolley coupleable to the track and configured to undergo translational motion while the shackle moves along the processing line.
